(19) United States
(12) Patent Application Publication
(10) Pub. No.: US 2008/0033765 A1
(43) Pub. Date: Feb. 7, 2008

(54) APPARATUS AND METHOD FOR CLAIMS REVIEW

(76) Inventors: Karen S. Knight, Skokie, IL (US); Zdenek J. Bauer, Chicago, IL (US); David Fennell, Downers Grove, IL (US); Rosemary Pavlina, Crown Point, IN (US); Rigoberto Vera, Joliet, IL (US); Imran Moinuddin Ahmed, Chicago, IL (US); Elizabeth Ann Srail, Chicago, IL (US)

Correspondence Address: MAYER BROWN LLP, P.O. BOX 2828, CHICAGO, IL, 60690, US

(21) Appl. No.: 11/697,684

(22) Filed: Apr. 6, 2007

Related U.S. Application Data
(60) Provisional application No. 60/790,371, filed on Apr. 6, 2006.

(51) Int. Cl. G06Q 40/00

(52) U.S. Cl. 705/4

(57) ABSTRACT

The present invention generally relates to a claims review system for electronic review of insurance claims. The claims review system contemplates several classes of users and comprises four modules, namely, a questionnaire module, a review module, an administration module, and a security module, that each implements an elective function of the review system. The questionnaire module allows specified users to create questionnaires used to gather information about a particular claim. Using the review module a specified user is able to perform reviews of the claims and respond to the questionnaires. The review module also allows a user to compare finalized reviews and to invite another user to view the comparison. The primary function of the administration module is to allow a user to track the location of physical claim files, and to input tracking information for physical files. Lastly, the security module may be used to create and to modify user roles for the system.

### REFERENCE TO RELATED APPLICATION

This application claims priority to U.S. Provisional Patent Application Ser. No. 60/790,371 filed Apr. 6, 2006, the entire contents of which is hereby incorporated by reference herein.

### BACKGROUND OF INVENTION

In order to ensure proper management of loss costs and consistent application of best practices, an insurer requires review of claims handled by the insurer. Claim reviews also serve to confirm that claims are being administered in a manner generally acceptable to regulatory, insurer, and industry standards. For instance, an insurer may wish to ensure that an assignment was prepared, determine that damages were calculated correctly, determine how the damages were calculated, and establish how the amount of damages was verified. Software may be used to facilitate this process. However, claims review software according to the teachings of the prior art was overly rigid in the identity of reviewers, disconnected from the physical files and had inadequate search features.

A significant amount of administrative costs and burden attends the use of prior art claims review systems. Careful review of claims is necessary as it minimizes fraud, reduces losses, allows the correction of unintentional errors, and additionally provides consistency of service for the insured. However, administratively rigid and complex claims review systems generally reduce the efficiency of the insurer's claims review process.

During recent years, the process of reviewing and adjudicating insurance claims has become increasingly automated. In the past, insurers' compliance staff and claims managers have spent an inordinate amount of time reviewing the claims. Without detailed review by compliance and claims managers, the insurer may never find out whether proper assignments were not obtained, claimed damages were not appropriately verified, or that the claim may have otherwise been handled in a manner not in compliance with regulatory, insurer, or industry standards. Furthermore, the file may not be as detailed as desired, leading to uncertainty, to potential inaccuracies, and ultimately to inefficiencies in providing proper claims review. With the advent of computerized management of the claims review process, the claims review process has become faster and more efficient. However, the automated systems did not provide for different levels of file review, did not track physical files, and did not have adequate search features.

Another problem with prior art claims review procedures is that insurers often need to change questionnaires in light of the changing needs of and practices in the insurer's business. Prior art claims review systems can be both difficult and time consuming for administrators to use when the information required to be gathered differs from previous claims, thus necessitating a new questionnaire.

In view of the foregoing, there is a need in the art for a more fully automated and comprehensive claims review system. For example, it would be an advancement in the art to provide a claims review system in which a variety of users, all with different access and review capabilities and responsibilities, could review a single claim file. Furthermore, it would be advantageous to provide a claims review system that could easily allow a user to electronically track the location of a physical claim file during the review process.

There also exists a need for a claims review system in which a user can invite another user to view results of the claims review process as a temporary user. In addition, there exists a need for a claims review system that allows a user to quickly modify and implement questionnaires as may be necessary.

### SUMMARY OF THE INVENTION

The present invention relates generally to an electronic claims review system for review of insurance claims. The claims review system utilizes network or other remote communication between computer processors, thereby increasing efficiency and decreasing the costs and time that have been associated with conventional claims review systems.

The claims review system contemplates several classes of users, including, but not limited to, administrators, bottom up reviewers, claim clerks, executive reviewers, guests, directors, and top down reviewers. Depending on the class of the user, varying roles and access capabilities will be assigned. For example, an administrator is the administrative manager of the claims review process, and in that capacity, the administrator has the ability to create questionnaires, assign and unassign reviews, create roles for other users, and finalize files. On the other hand, a guest cannot complete reviews, but only has the ability to view comparisons performed by an executive reviewer when invited to do so. The present invention provides the ability for a variety of users, all with different access and review capabilities, to review a single claim file. In addition, the present invention has the functionality to track the location of the physical claim file during the review process.

The claims review system comprises four modules, namely, a questionnaire module, a review module, an administration module, and a security module, that each implements an elective function of the review system. The questionnaire module allows specified users to create questionnaires used to gather information about a particular claim. Using the review module, a specified user is able to perform reviews of the claims and respond to the questionnaires. The review module also allows a user to compare finalized reviews and invite another user to view the comparison. The primary function of the administration module is to allow a user to track the location of physical claim files, and to input tracking information for physical files. Lastly, the security module may be used to create and modify user roles for the system.

It is to be understood that both the foregoing general description and the following detailed description are exemplary and provided for purposes of explanation only, and are not restrictive of the invention, as claimed. Further features and objects of the present invention will become more fully apparent in the following description of the preferred embodiments and from the appended claims.

The accompanying drawings, which are incorporated in and constitute part of this specification, are included to illustrate and provide a further understanding of the method and system of the invention. Together with the description, the drawings serve to explain the principles of the invention.

### BRIEF DESCRIPTION OF DRAWINGS

In describing the preferred embodiments, reference is made to the accompanying drawing figures wherein like parts have like reference numerals, and wherein:

FIG. 1 depicts a claims review system in accordance with an embodiment of the present invention;

FIG. 1a depicts a claims review system comprising modules in accordance with the principles of the present invention;

FIG. 2 depicts a flow chart illustrating steps performed when a user is answering a questionnaire in accordance with the principles of the present invention;

FIG. 3 depicts a flow chart illustrating steps performed after a user chooses to create a questionnaire in accordance with the principles of the present invention;

FIG. 4 depicts a flow chart illustrating steps performed after a user chooses to remove a questionnaire in accordance with the principles of the present invention;

FIG. 5 depicts a flow chart illustrating steps performed after a user chooses to create a new question in accordance with the principles of the present invention;

FIG. 6 depicts a flow chart illustrating steps performed after a user chooses to add an existing question in accordance with the principles of the present invention; and

FIG. 7 depicts a flow chart illustrating steps performed after a user chooses to copy an existing phase in accordance with the principles of the present invention.

It should be understood that the present invention is not limited to the preferred embodiments illustrated.

### DETAILED DESCRIPTION OF THE INVENTION

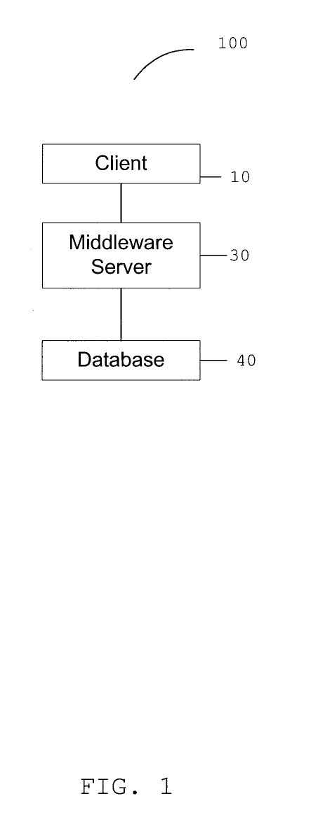

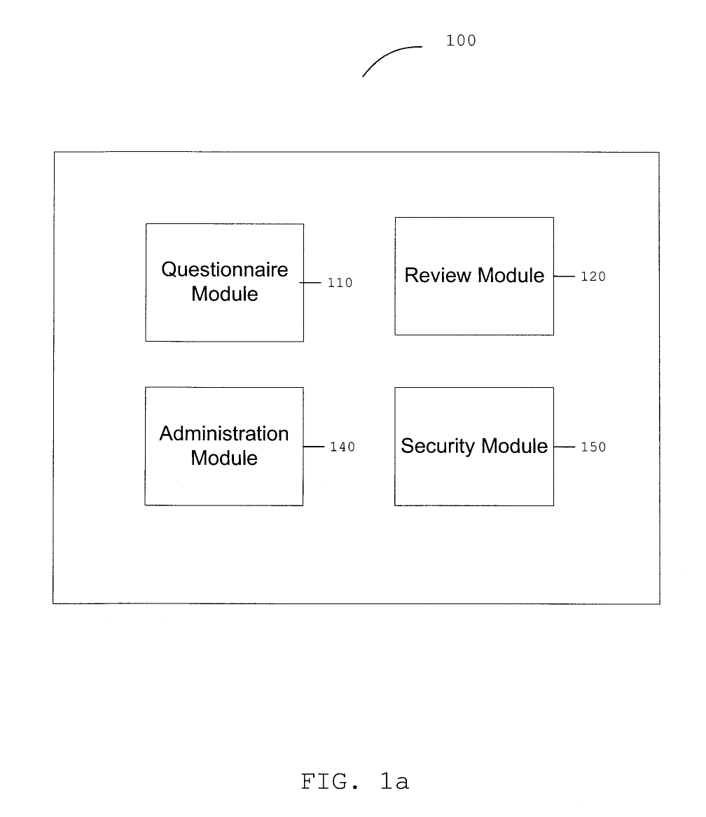

Referring generally to FIGS. 1-7, and upon review of this description, it will be appreciated that the apparatus of the present invention generally may be embodied within numerous configurations.

FIG. 1 shows a claims review system 100 according to an embodiment of the present invention. It comprises a client 10, middleware server 30, and database 40. The client 10 is operated by a user, who interacts with the middleware server through a web browser. The middleware server 30 receives commands from the user and displays web pages to the user. The middleware server 30 also sends queries to the database server 40, when appropriate. Database 40 stores the persistent data required by the system. For instance, database 40 may store questionnaires and responses to the questionnaire. Middleware server 30 may be an enterprise server running WEBSPHERE APPLICATION SERVER, by IBM Corporation of Armonk, N.Y. Various modules, to be discussed below, may run on the middleware server 30. In a preferred embodiment, these modules are based on the JAVA 2 PLATFORM, ENTERPRISE EDITION (J2EE), by Sun Microsystems, Inc. of Santa Clara, Calif. Database 40 is preferably a server running a relational database by Oracle, Inc., of Redwood Shores, Calif. Client 10 is preferably a workstation running WINDOWS by Microsoft Corporation of Redmond, Wash. One of ordinary skill in the art would understand that the above system layout and software configuration is only exemplary, and may be modified yet remain in the spirit of the disclosed invention.

The claims review system 100 according to an embodiment of the present invention contemplates several classes of users. The first is the administrator. The administrator is not a reviewer, but rather is the administrative manager of the review process. The administrator has the ability to create questionnaires, assign and unassign reviews, and activate and inactivate questionnaires. The administrator may create roles, assign permissions to the roles, and assign users to the roles. The administrator may create and remove files, finalize files and questionnaires, and unfinalize files and questionnaires. The second is the bottom up reviewer. The bottom up reviewer is typically the owner of the file in question, e.g., a claims adjuster, but may also be a manager of the owner of the file, e.g., a claims manager. The third class of users is the clerk. The clerk has the ability to assign and unassign reviews, as well as track physical files using the system. The clerk may also enter tracking data into the system, e.g., the location of the file. The fourth is the executive reviewer. The executive reviewer cannot complete reviews, but rather has the ability to compare bottom up and top down reviews of the same file. The fifth is the guest. The guest cannot complete reviews, but has the ability to view comparisons performed by an executive reviewer, when invited to do so. The sixth is the director. The director is the business manager of the review process. The director may view all bottom up reviews, top down reviews and appeal reviews. The director may complete final appeal reviews. The seventh is the top down reviewer. The top down reviewer is typically a member of the insurance company's compliance department, and has the ability to complete top down reviews and appeal reviews.

In a preferred embodiment, there are four different levels of review. The lowest is the bottom up review. The next level is the top down review. For each file selected for review, preferably both a bottom up and top down review are performed. After the bottom up and top down reviews are performed, the file may be calibrated. Calibration is the third level of review, and is a process by which the bottom up reviewer's performance is evaluated. The bottom up review is compared to the top down review. Ideally, the reviews are identical. However, this is usually not the case, so there may be some discrepancies between the bottom up and top down reviews. If the discrepancies are significant or otherwise unresolveable, the file may proceed to the fourth level, the appeal review.

Referring to FIG. 1a, the claims review system 100 according to an embodiment of the present invention comprises four modules, the questionnaire 110, review 120, administration 140 and security 150 modules. These modules are preferably embodied in software running on the middleware 30 and communicate with client 10 and database 40. The operation of each of these modules will be hereinafter described.

The primary purpose of the questionnaire module 110 is to allow a user to create questionnaires. Questionnaires are a series of questions about a claim. In a preferred embodiment, each questionnaire is associated with only a single line of business. Questions may be created by the user, or the user may select questions from a question library. The user may create rules in a questionnaire, preferably associated with a question. For instance, based on a response to an earlier question, the current question may be skipped. Or, based on a response to the current question, the system may jump to a later question. Also, URL references may be embedded in the question. These URLs could, for instance, link to standards used in evaluating a claim. The questionnaire module 110 may allow a user to enable comments for a question. Comments for a question are not answers to the question, but rather allow a reviewer to enter information other than the answer which may be helpful to other reviewers. Preferably, a reviewer should be able to enter multiple comments for each question. A user may also group questions into phases. The user may select names for each phase, as well as an order for the phases. Some examples of various phases of the claims process are file creation and assignment, initial investigation, case reserves, compensability decision, damage verification, payment, medical and disability management, litigation management, file disposition, subrogation and recovery, assignment, coverage initial contract, liability investigation, damage investigation, case reserves, settlement evaluation, negotiation, litigation management, and recovery. Preferably, the system requires each question to be associated with a phase. A user may also select whether a question is mandatory or optional. A user may go back and edit, move or remove questions. After the user is satisfied with the form of the questionnaire, the user may finalize the questionnaire. If all mandatory questions have not been answered, the system may identify the unanswered mandatory questions and refuse to finalize the questionnaire. The user may select a questionnaire to be a default questionnaire for a given line of business. Preferably, only an administrator has the ability to create a questionnaire. Questionnaires may also be specific to individual lines of business. For instance, a questionnaire may be specific to the insurance company's general liability, property or professional liability lines.

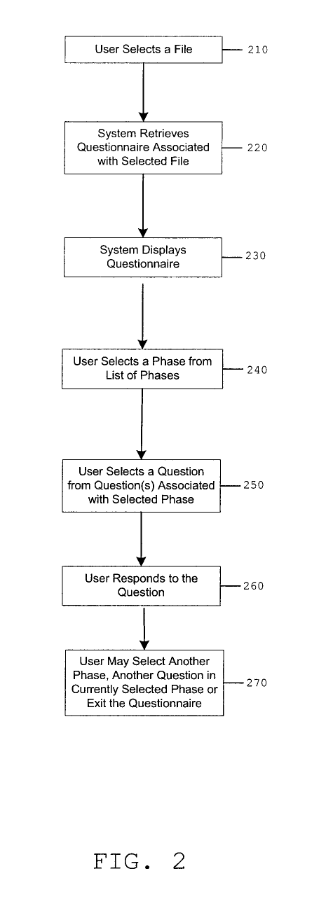

The review module 120 is the module that allows a user to perform reviews. A function of the review module 120 is that it allows a user to respond to questionnaires constructed using questionnaire module 110. Answering a questionnaire is illustrated in connection with FIG. 2. At step 210, the user selects a file. To do so, the user may enter a known file ID or claim ID associated with the file. Alternatively, the user may search for files assigned to the user, and then select the file from a list, preferably stored in a drop-down menu. The user may order the search results by due date. At step 220, the questionnaire associated with the selected file is retrieved by the system. At step 230, the system displays the questionnaire to the user. At step 240, the user selects a phase from a list of phases. At step 250, the user selects a question from among the question or questions associated with the selected phase. Alternatively, the system may display all questions for a given phase to user at once. At step 260, the user responds to the question. At this point 270, the user may select another phase, or may select another question in the currently selected phase, or may exit the questionnaire. If the user exits, the user may save the progress for later or, if all mandatory questions are answered, the user may finalize the questionnaire. The review module 120 may provide some additional features. For instance, the review module 120 may spell-check user responses, capture time stamps and user identification for responses and finalization of reviews, and populate various fields (such as the claim number and user identification) automatically. The review module 120 may provide a calculator pop-up for questions requiring numeric responses, and may provide a calendar pop-up for questions requiring date responses. The review module 120 may flag all mandatory questions.

The review module 120 may also allow a user to compare finalized reviews and invite another user to view the comparison. The other user need not be a registered user of the system, but may be granted limited guest status to review the comparison. The system provides an interface to the user allowing the user to search for users. Note that the two finalized reviews are preferably both associated with the same file, only performed by two separate reviewers. A user may compare reviews by first selecting two finalized reviews, or the file to which the two reviews are associated, to compare. The user may then display the finalized reviews, side-by-side. Differences in responses between the two finalized reviews may be flagged to the user, and the comparison may be saved by the system. The user may choose to send another user a link to the comparison. Then, the user may view that comparison, without having the ability to view any other comparison.

The review module 120 allows a user to calibrate a review. Calibration is the third level of review, and is a process by which the bottom up reviewer's performance is evaluated. The bottom up review is compared to the top down review. Ideally, the reviews are identical. However, this is usually not the case, so there may be some discrepancies between the bottom up and top down reviews. The system 100 may present to the user a screen identifying which responses of the bottom up reviewer are identical to those of the top down reviewer, and which are different. If the discrepancies are significant or otherwise unresolveable, the file may proceed to the fourth level of review, the appeal review. Calibration is typically performed by a bottom up reviewer, so that the bottom up reviewer may evaluate his or her review performance

The review module 120 may also allow a user to assign or reassign files to other users. The review module 120 may allow a user to enter comments as to why a file is assigned or reassigned. If a review is already in progress before a file is reassigned to another user, the progress is preferably deleted, so that the new user may start the review with a fresh slate. When a file is assigned or reassigned to a user, the system may automatically generate an e-mail informing the user of the assignment.

The primary function of administration module 140 is to allow a user to track the location of physical files, and to input tracking information for physical files. This is useful as the physical files are required to perform the reviews. A user first selects a file. Then, the system displays a tracking page for that file to the user. The tracking page may show the current location of the file and the name of the reviewer assigned to the selected file. The user may then enter a date and select or enter a location to indicate that, for instance, one of the following had occurred: the file was received from a remote location; the file was sent to a reviewer; the file was received from the reviewer; or the file was shipped to a remote office. Alternatively, the administration module 140 may utilize bar code scanners at various locations to partially automate the tracking of files. The administration module 140 would then update the location of a file when that file is scanned.

Security module 150 may be used to create and modify roles for the system. Each role has a number of permissions associated therewith. For instance, various roles have the authority to create questionnaires, modify questionnaires, remove questionnaires, answer questionnaires, or assign questionnaires. Each role may also have a specific region or regions, or a specific line of business or lines of business associated therewith. Finally, each role may have one or more users assigned to the role. For instance, the roles could be the classes of users outlined above (i.e., administrator, bottom up reviewer, clerk, executive reviewer, guest, director, and top down reviewer). For instance, a bottom up reviewer will preferably be limited to the bottom up reviewer's region and line of business, whereas a top down reviewer may only be limited to the top down reviewer's line of business.

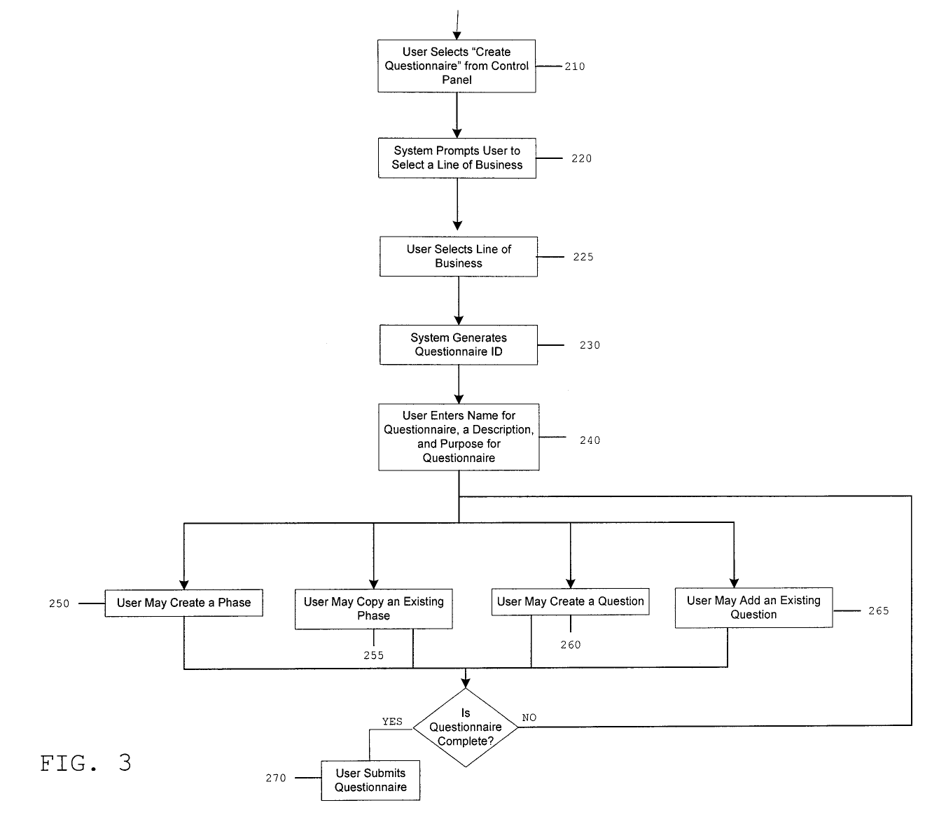

FIG. 3 is a flow chart illustrating a user creating a questionnaire. The user, typically an administrator, first selects 210 “Create Questionnaire” from the administrator control panel. The system then prompts the user to select 220 a line of business for the questionnaire. The user then selects 225 a line of business. The system then generates 230 a unique questionnaire ID for the created questionnaire. The user then enters 240 a name for the questionnaire, a description of questionnaire, and a purpose for the questionnaire. Alternatively, the user may enter a name, description and purpose at step 225. In another embodiment, instead of creating a new questionnaire, the user may select an existing questionnaire to edit. The user has four options at this point. First, the user may create 250 a phase. This is performed by generating a new phase ID and associating the ID with the questionnaire. Second, the user may copy 255 an existing phase. Third, the user may create 260 a question. Fourth, the user may add 265 an existing question. The system may require that questions be added or created only to an already existing phase. So, if no phase has yet been created or copied, the user may not have the option to create a question or add an existing question. The user repeats these tasks until the questionnaire is complete, at which point the user submits 270 the questionnaire. Alternatively, if the questionnaire is not complete, but the user wishes to perform a different task, then the user may save 280 the questionnaire as a draft.

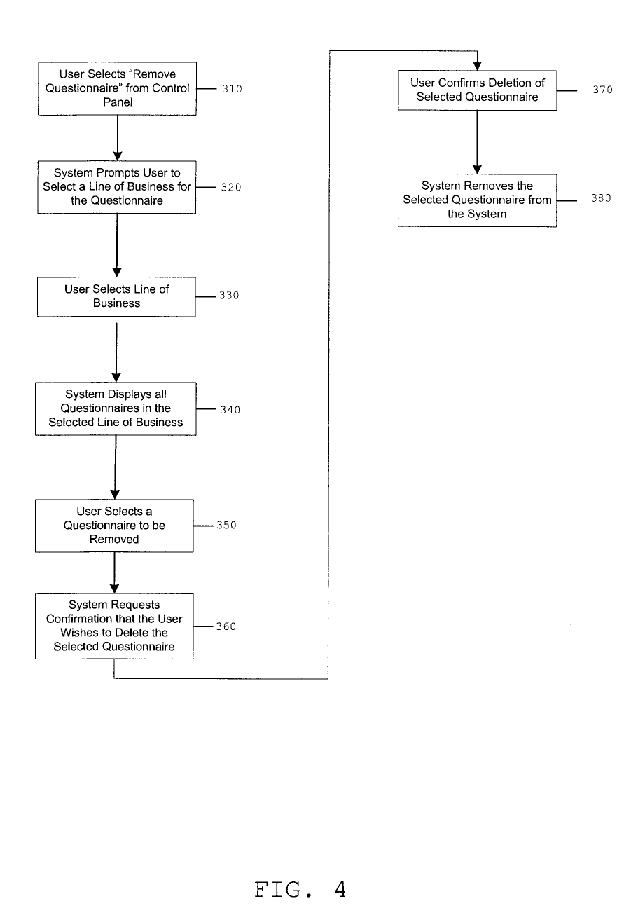

FIG. 4 is a flow chart illustrating a user removing a questionnaire. The user, typically an administrator, first selects 310 “Remove Questionnaire” from the administrator control panel. The system then prompts the user to select 320 a line of business for the questionnaire. The user then selects 330 the line of business of the questionnaire that the user wishes to remove. The system then displays 340 all questionnaires in the selected line of business. The user selects 350 a questionnaire to be removed within the selected line of business. The system then requests 360 confirmation that the user wishes to delete the selected questionnaire. The user then confirms 370 deletion of the selected questionnaire. At steps 350 or 370, the user may optionally enter a reason for deleting the questionnaire in a text field provided for that purpose. The system then removes 380 the selected questionnaire from the system by, for instance, deleting the questionnaire from the database 40.

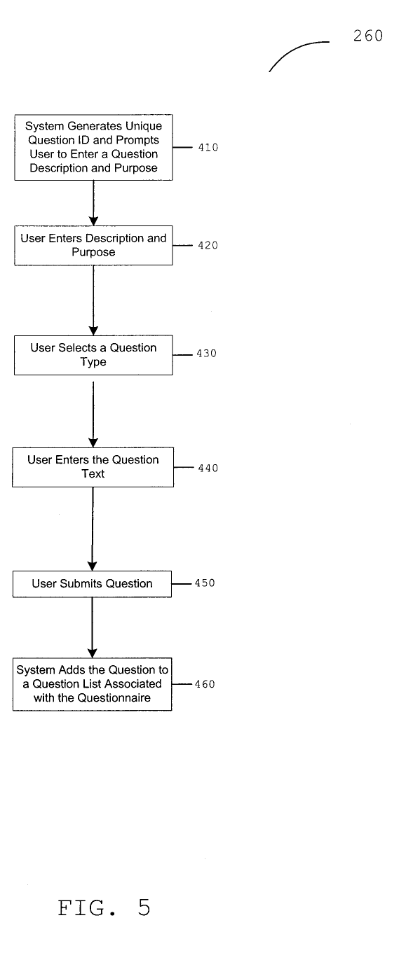

FIG. 5 illustrates step 260 in more detail. After a user has chosen to create a new question, the system generates 410 a unique question ID and prompts the user to enter a question description and purpose. The user then enters 420 a description of and purpose for the question. The user may also select a phase for the question. The user then selects 430 a question type. For instance, the question may be a multiple-choice question, may require a numerical response, may require a yes/no response, or may require the entry of narrative text. The user then enters 440 the question text as well as any responses, if necessary. In this step, the user may also create rules associated with the new question at this step. The user then submits 450 the question. The system then adds 460 the question to a question list associated with the questionnaire. Alternatively, the system may only associate the question to the questionnaire by providing a pointer or reference to the question.

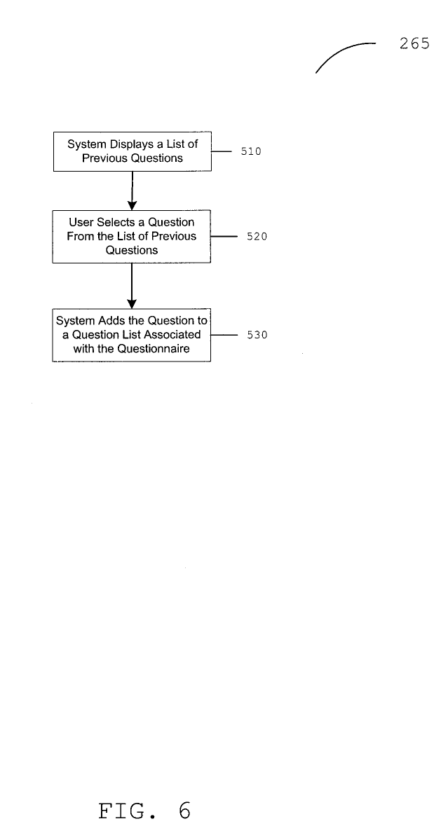

FIG. 6 illustrates step 265 in more detail. After a user has chosen to add a new question, the system displays 510 a list of previous questions. The user then selects 520 a question from the list of previous questions. The system then adds 530 the question to a question list associated with the questionnaire. Alternatively, the system may associate the question to the questionnaire by associating a pointer or reference with the questionnaire. The question is preferably associated with a phase of the questionnaire as well.

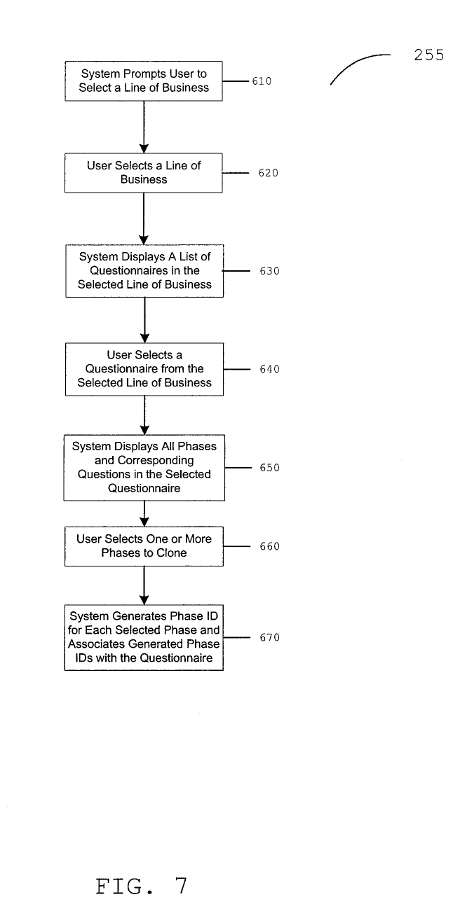

FIG. 7 illustrates step 255 in more detail. After a user has chosen to copy an existing phase, the system prompts 610 the user to select a line of business. The user then selects 620 a line of business. The system then displays 630 to the user a list of questionnaires in the selected line of business. The user then selects 640 a questionnaire from the selected line of business. In an alternative embodiment, the user may select a line of business and questionnaire on the same screen. The system then displays 650 to the user all phases in the selected questionnaire, as well as the questions within each phase. The user then selects 660 one or more phases that the user wishes to clone. The system then generates 670 one phase ID for each selected phase, and associates the generated phase IDs with the questionnaire. This functionality makes it easy to add a number of questions to a questionnaire all at once.

It should be appreciated that merely preferred embodiments of the invention have been described above. However, many modifications and variations to the preferred embodiments will be apparent to those skilled in the art, which will be within the spirit and scope of the invention. Therefore, the invention should not be limited to the described embodiments. To ascertain the full scope of the invention, the following claims should be referenced.

What is claimed is:

1. A system for reviewing an insurance claim file comprising:
a questionnaire module to enable a first user to create a questionnaire, wherein the questionnaire comprises at least one question;
a review module to enable a second user and a third user to complete the questionnaire independently to create first and second response sets, respectively, and wherein the review module displays a comparison of the first response set to the second response set, and indicates whether responses in the first response set are identical to those of the second response set;
an administration module for tracking a location of a physical file associated with the claim file and inputting tracking information for the physical file; and
a security module for creating and modifying a role for the system.

2. The system of claim 1, wherein the questionnaire module further enables the first user to create the at least one question or to select the at least one question from a question library.

3. The system of claim 2, wherein the questionnaire module further enables the first user to assign the at least one question to a phase.

4. The system of claim 1, wherein the questionnaire module further enables the first user to remove the questionnaire from a database.

5. The system of claim 1, wherein the questionnaire module further enables the first user to input a description and a purpose for the at least one question.

6. The system of claim 1, wherein the review module allows a fourth user to view a comparison of the response of the second user to the at least one question to the response of the third user to the at least one question.

7. The system of claim 6, wherein the review module allows a fifth user to view a comparison of the response of the second user to the at least one question to the response of the third user to the at least one question after the fourth user views the comparison, and wherein the fifth user is a supervisor of the fourth user.

8. The system of claim 1, wherein the review module displays a comparison by displaying the responses of the first response set and the responses of the second response set side by side.

9. The system of claim 8, wherein the review module indicates whether the responses in the first response set are identical to those of the second response set by displaying a symbol representing identity next to identical responses in the first and second response sets.

10. The system of claim 1, wherein the review module enables a second user or a third user to invite a guest user to view the comparison.

11. The system of claim 1, wherein the administrative module enables a fourth user to search for the current location of the physical file associated to the claim file.

12. The system of claim 1, wherein the administration module displays a tracking page for the physical file, and wherein the tracking page displays to a user the current location of the file and a name of a user assigned to review the file.

13. The system of claim 1, wherein the administration module utilizes bar code scanners in order to automate the tracking of the tracking file.

14. The system of claim 1, wherein the security module enables a user to associate a role with at least one permission, and wherein the at least one permission defines a region, a line of business, or review level associated with the role.

15. A method of evaluating adjustment of a claim comprising:
a first user completing a questionnaire regarding the adjustment of the claim;
a second user completing a questionnaire regarding the adjustment of the claim;
displaying to the first user or second user a comparison of the first user's responses to the questionnaire and the second user's responses to the questionnaire; and
identifying to the first user or second user identical and non-identical responses.

16. The method of claim 15, further comprising displaying the first user's responses and the second user's responses side-by-side.

17. The method of claim 15, wherein the first user or second user is able to invite at least one guest to view the comparison.
